(19) United States
(12) Patent Application Publication
(10) Pub. No.: US 2012/0123913 A1
(43) Pub. Date: May 17, 2012

(54) AUTOMATED PAYROLL RECONCILIATION

(76) Inventor: SREESHA M, Bangalore (IN)

(21) Appl. No.: 12/945,911

(22) Filed: Nov. 15, 2010

(51) Int. Cl. G06Q 10/00

(52) U.S. Cl. 705/30

(57) ABSTRACT

Various embodiments of systems and methods for automated payroll reconciliation are described herein. One or more identifiers, one or more payment parameters, and one or more time references for one or more data entering operations of a plurality of related systems are captured and stored. A query is initiated based on a user-selection for reconciliation of at least a first system and a second system of the plurality of systems. A reconciliation report comprising a collation of the identifiers, the payment parameters and the time references of the first system and the second system is generated in response to the query.

### FIELD

The field relates generally to payroll-related methods and systems. More particularly, the field is related to automation of payroll reconciliation.

### BACKGROUND

An organization typically includes several internal systems to ensure smooth flow of organizational processes. Some systems may be required to maintain financial data and ensure consistency and accuracy of financial data. Examples of such systems include a human resource (HR) payroll system and a financial accounting system. A HR payroll system processes payments to employees and other human resources of an organization. The payroll system calculates various payments such as basic remuneration, overtime payments, bonus, and other special payments. Relevant payroll results from the payroll system can be transferred or posted to a financial accounting system.

A financial accounting system can be used for meeting statutory requirements and preparing operational information (e.g. financial reports) of an organization. A financial accounting system records and manages accounting data of an organization. In addition to payroll and financial accounting systems, there can be several other systems related to a variety of expenses. An example of such systems is a travel management system that can be used to settle travel expenses incurred by employees.

Payroll reconciliation is a comparison process where payroll results are compared against data from related systems such as, for example, financial accounting, travel management, and fund management. Reconciliation is performed for assessing accuracy and consistency of data flow between the payroll system and the related systems within an organization. Currently, reconciliation is performed by executing various reports in the respective system (e.g. payroll, financial accounting and travel management) and comparing their output. This comparison is generally performed external to an enterprise system. Typically, report outputs are downloaded to spreadsheets and comparison is performed manually using the spreadsheets. However, such manual comparison is extremely time consuming, resource (e.g. accounting personnel) intensive, and prone to error.

It would therefore be desirable to automate payroll reconciliation for reducing manual effort and eliminating errors in the process of reconciliation.

### SUMMARY

Various embodiments of systems and methods for automated payroll reconciliation are described herein. Identifiers, payment parameters, and time references for data entering operations of a plurality of related systems are captured and stored. A query is initiated based on a user-selection for reconciliation of at least a first system and a second system of the plurality of systems. A reconciliation report is then generated in response to the query. The reconciliation report which comprises a collation of the identifiers, the payment parameters and the time references of the first system and the second system is generated.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a plurality of systems, according to one embodiment.

FIG. 2 is a block diagram of a method for payroll reconciliation, according to one embodiment.

FIG. 3 is a block diagram illustrating data capturing, data storing and payroll reconciliation report generation, according to one embodiment.

FIG. 4 is a block diagram illustrating exemplary data captured for data entering operations of a payroll system, a financial accounting system, and a travel management system, according to one embodiment.

FIG. 5 illustrates an exemplary payroll reconciliation report of a payroll application and a financial accounting application, according to one embodiment.

FIG. 6 illustrates an exemplary payroll reconciliation report of a payroll application, a financial accounting application, and a travel management application, according to one embodiment.

FIG. 7 is a block diagram of an exemplary computer system according to one embodiment.

### DETAILED DESCRIPTION

Embodiments of techniques for automated payroll reconciliation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

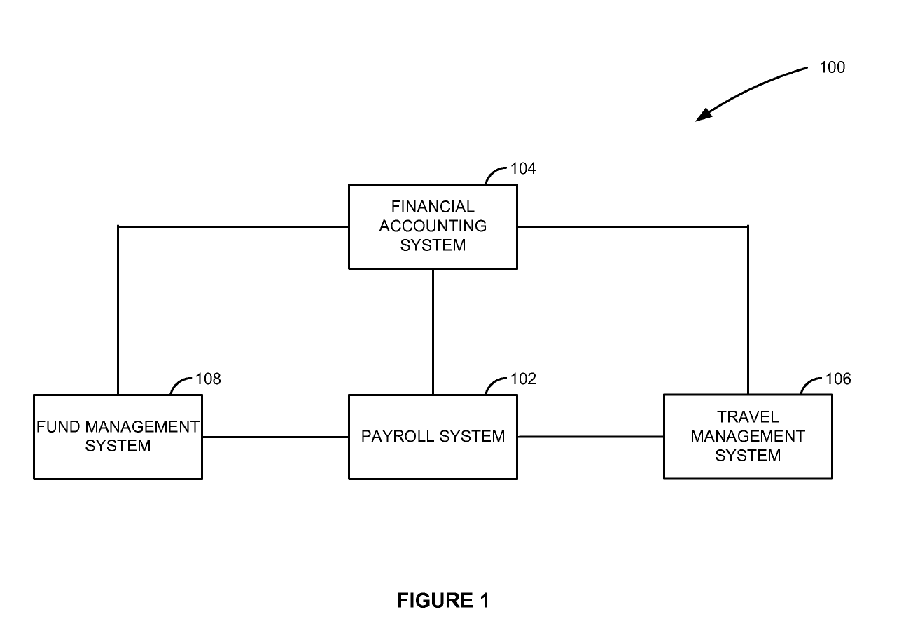

FIG. 1 is a block diagram of a plurality of systems within an organization. An organization includes several internal systems related to human resources (HR) payroll, finances, budgeting, accounting, tax, and expenses. All these systems can be integrated as part of an enterprise system 100 (e.g. SAP® Enterprise Resource Planning system (ERP)). These systems include associated databases and application components that provide user interfaces. Relevant operations can be performed using these systems via the user interfaces and data is entered in the associated databases. Some examples of these systems include a payroll system 102, a financial accounting system 104, and a travel management system 106. The payroll system 102 is used to process remuneration of human resources (e.g. employees) of an organization. The financial accounting system 104 can be used to record, manage, and summarize financial transactions of an organization. The travel management system 106 can be used to process travel expenses incurred by employees of an organization. These systems are related in that they are part of an ERP system and the data from one application may be used or transferred to another application depending on the type of applications or type of the operations performed using an application.

The payroll system 102 calculates gross pay and net pay, which may include individual payments and deductions calculated during a payroll period. In addition to remuneration, the payroll system 102 may also process bonuses, overtime payments, and any other special payments. The payroll process is typically run at a specific time for a time period (e.g. weekly, biweekly, monthly) depending on the organizational policies.

After the payroll run, the payroll results can be transferred to the financial accounting system 104. Transfer of results from the payroll system 102 or other related system to the financial accounting system 104 can be referred as ‘posting.’ Following which, payments to the employees can be made by a check or direct bank transfer. In the financial accounting system 104, business transactions can be recorded according to a document principle, which provides an unbroken audit trail from financial statements to individual documents. Business transactions can be entered in general ledger and sub ledgers by creating documents. A document can be posted if the balance of debits and credits in the document is zero. The financial accounting system 104 can then save the document and update the general ledger account balances.

Payment of travel expenses can be made via the payroll system 102, the financial accounting system 104, or a data medium exchange. In one embodiment, the travel management system 106 is integrated with the payroll system 102. In which case, the travel expense results can be transferred from travel management system 106 and taken into consideration in the payroll system 102. The transfer of travel expense results enables one to carry out payment of travel expenses via the payroll system 102. Travel expense results can also be posted to the financial accounting system 104.

Similarly, systems related to other expenses and financial operations can be integrated with the payroll system 102 and/or financial accounting system 104. For example, a fund management system 108 can be integrated with both the payroll system 102 and the financial accounting system 106. A fund management system 108 can be used to create budgets and perform various budget-related operations. For example, the fund management system 108 can be used to budget revenues and expenditures for individual responsibility areas, monitor future funds movements in light of the available budget, and prevent budget overruns. The fund management application 106 can also be integrated with the travel management system (e.g. to monitor travel costs, to assign travel expenses in accordance with a budget).

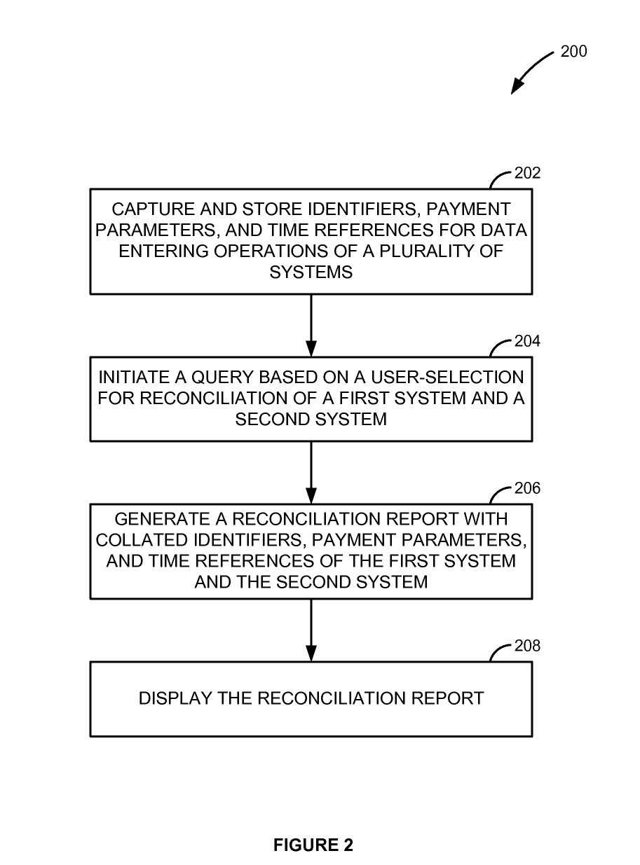

FIG. 2 illustrates an embodiment of a method 200 of payroll reconciliation. Several activities can be performed using the systems described previously. For example, payroll calculations and payroll runs can be performed using the payroll system. Transactions can be recorded and posted in general ledgers and sub-ledgers using the financial accounting system, travel expenses can be recorded using the travel management system, and budgets can be created using the fund management system. These activities lead to data entering operations, wherein data resulting from such activities is entered in associated databases. This entered data is typically used for performing reconciliation between the systems and is spread over a plurality of databases. However, currently, while entering the data, the traceability and granularity of the data may not be preserved to an extent required to successfully perform reconciliation. There could be missing information that may not be entered into the databases. This missing information could be crucial in performing reconciliation. Also, since the data is spread over a plurality of databases, reconciliation is currently performed by generating reports in each system separately and comparing the reports manually. The method 100 of payroll reconciliation aims to solve these problems and automates the process of payroll reconciliation.

At 202, identifiers, payment parameters, and time references for the data entering operations are captured and stored in a data warehouse. Data fields can be created and assigned names so that the captured data can be stored in respective data fields. In one embodiment, the data warehouse is a SAP® Business Information Warehouse (SAP® BW). Data warehousing feature in SAP® BW provides extraction of data for analysis and interpretation, among various other features. In one embodiment, a set of data including an identifier, a payment parameter, and a time reference is captured for a data entering operation. In the case of the payroll system, the identifier can include an employee identification number, a payment parameter can include payment type (e.g. basic pay, superannuation, etc) and a payment amount associated with the payment type, and a time reference can include a posting date. The employee identification number, the payment amount, the payment type, and the posting date are captured and stored in a data warehouse.

In the case of financial accounting system, the identifier can include a general ledger account number and an employee identification number, a payment parameter can include payment type (e.g. basic pay, superannuation, etc) and a payment amount associated with the payment type, and a time reference can include a posting date. In the case of travel management system, the identifier can include a trip number, a payment parameter can include a travel expense type (e.g. per diem) and amount associated with the travel expense, and a time reference can include a posting date.

In one embodiment, a first time reference is captured and a second time reference is determined from the first time reference. The first time reference can be a posting date and the second time reference can be a pay period. Depending on the posting date, the pay period can be determined. For example, the pay period for all posting dates falling in January can be determined as pay period ‘1.’ Both the first time reference and the second time reference can be stored.

At 204, a query is initiated based on a user-selection for reconciliation of a payroll system and a second system including at least one of a financial accounting system, a travel management system, and a fund management system. In one embodiment, a user can be provided with an interface to perform the payroll reconciliation. This interface can be provided by a reconciliation application that can be integrated with an Enterprise Resource Planning system (ERP) application. In one embodiment, a reconciliation application can be implemented in SAP® ERP system or SAP® NetWeaver®. A user may select payroll reconciliation between the payroll system and a financial accounting system according to certain conditions. These conditions can include, for example, a specific period for reconciliation. Depending on the user-selection, the query can be generated. This query is initiated to retrieve data from the data warehouse where information captured from various systems is stored. The query can include a list of data field names in the data warehouse.

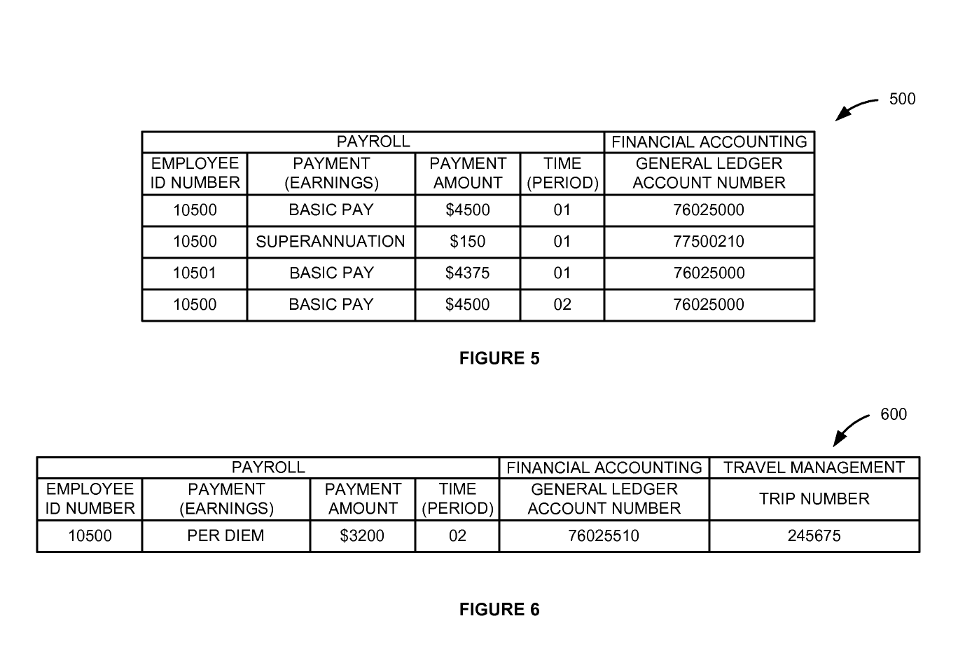

At 206, a reconciliation report is generated using the information retrieved from the data warehouse in response to the query. The reconciliation report includes a collation of identifiers, payment parameters, and time references of the payroll system and the second system. If the user selection includes reconciliation of the payroll system and the financial accounting system, then the reconciliation report is generated to include employee identification number (an identifier of the payroll system), general ledger account number (an identifier of the financial accounting system), a list of payment types, payment amounts associated with the payment types, and time references associated with the data entering operations of the payroll system and the financial accounting system. Examples of the reconciliation reports are described in reference to FIGS. 5 and 6.

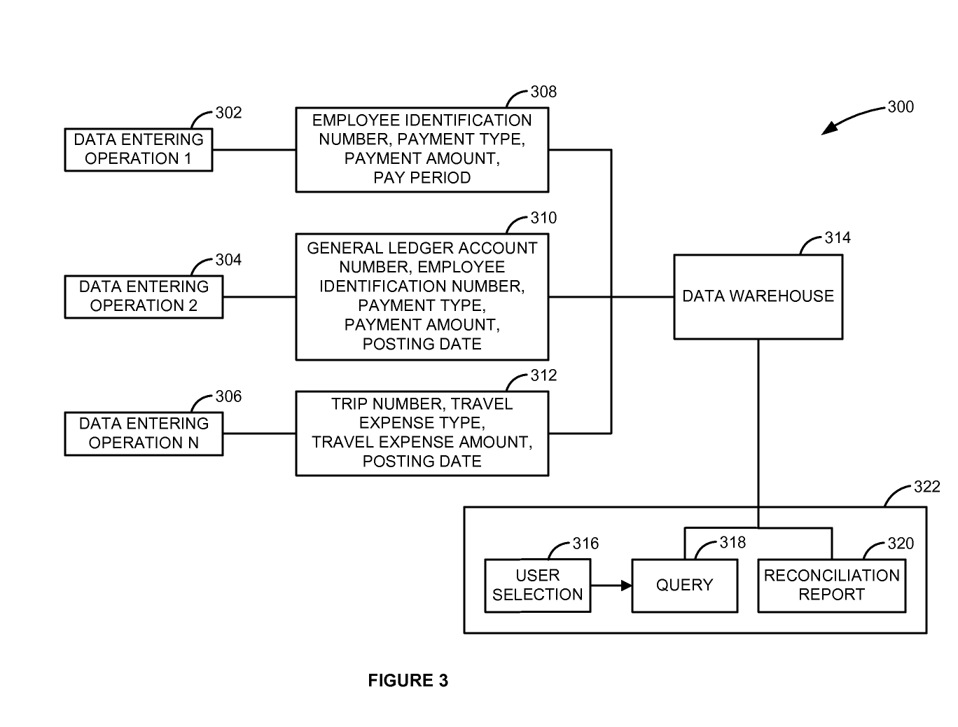

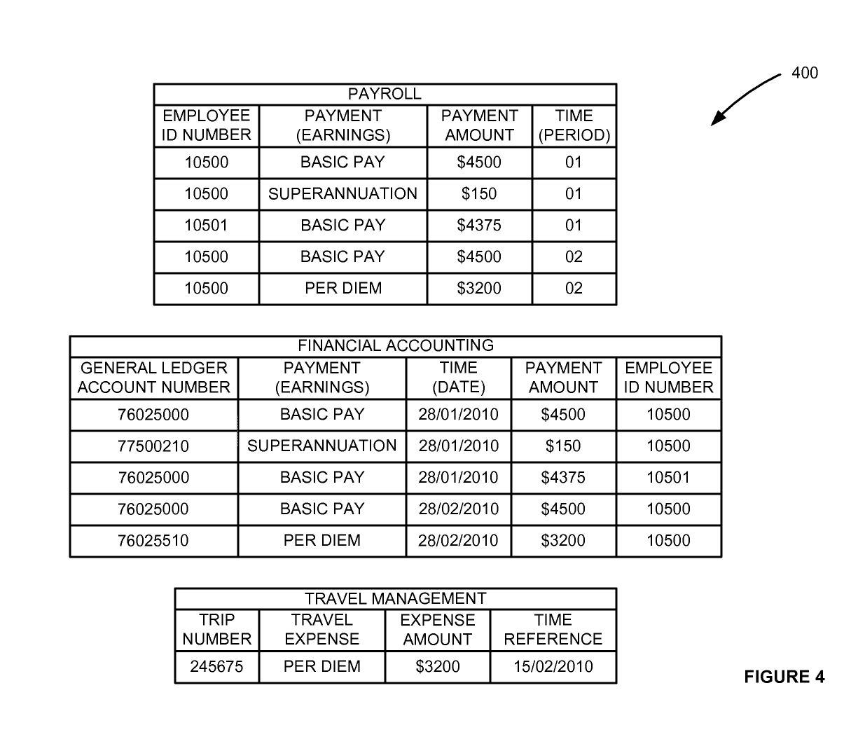

FIG. 3 illustrates a block diagram 300 of data capturing, data storing and payroll reconciliation report generation and FIG. 4 illustrates exemplary data 400 captured for data entering operations of a payroll system, a financial accounting system, and a travel management system, according to one embodiment. There can be several data entering operations associated with systems. As an example, it is assumed that the data entering operation ‘1’ 302 is associated with a payroll system, the data entering operation ‘2’ 304 is associated with a financial accounting system, and the data entering operation ‘n’ 306 is associated with a travel management system. Employee identification number, payment type, payment amount and a pay period are captured 308 for the data entering operation ‘1’. General ledger account number, employee identification number, payment type, payment amount, and posting date are captured 310 for the data entering operation ‘2.’ Trip number, travel expense type, travel expense amount, and posting date are captured 312 for the data entering operation ‘n’. The captured data is stored in a data warehouse 314.

A user can then select for reconciliation of a payroll system and a second system for a specific timeframe. In one embodiment, a reconciliation application 322 can be provided. A user can select two or more systems for reconciliation using a user interface of the reconciliation application. If the user-selection 316 includes payroll and financial accounting systems, a query 318 can be generated and initiated to retrieve data stored in the data warehouse 314. A reconciliation report 320 is then generated by collating the retrieved data. Specifically, identifiers, payment parameters, and time references of the payroll system and financial accounting system are collated in the reconciliation report 320. The reconciliation report 320 is then presented to the user. The reconciliation report 320 can be displayed on the user interface of a reconciliation application 322.

Reconciliation primarily includes comparison of data and, if a discrepancy exists, further drilling down of data. The reconciliation application may provide the user with an option to select a level of detail for generating the report. For example, a user can select a lower level of detail by selecting an employee group. There can be an identifier for that employee group that can be captured and stored in the data warehouse 314. If there is a discrepancy in the payment amounts shown in the reconciliation report 320, the user can then select a higher level of detail such as selecting individual employee level.

FIG. 5 illustrates an exemplary reconciliation report 500 that can be displayed to a user. The reconciliation report 500 is generated based on a user selection of reconciliation between a payroll system and a financial accounting system. The reconciliation report 500 includes employee identification numbers (e.g. 10500), general ledger account number (e.g. 76025000), payment type (e.g. basic pay), and payment amounts associated with the payment types. The reconciliation report 500 also includes a time reference, namely, pay periods. The data displayed in the report 500 is collated from the data that is captured and stored (shown in FIG. 4) for data entering operations of the payroll system and financial accounting system. Specifically, employee identification numbers, payment types, payment amounts, and time references of the payroll system and employee identification numbers, general ledger account numbers, payment types, payment amounts, and time references of the financial accounting systems are collated to generate the reconciliation report 500. The posting dates of the financial accounting system are used to determine the pay periods and collate with the pay periods of the payroll system during the process of generation of reconciliation report 500. As described previously, for example, the pay period for all posting dates falling in January can be determined as pay period ‘1,’ the pay period for all posting dates falling in February can be determined as pay period ‘2,’ and so on.

In this reconciliation report 500, no discrepancy exists between payment types and payment amounts of the payroll system and the financial accounting system. From the reconciliation report 500 it can be interpreted that basic pay is debited to general ledger account number 76025000 for employees (e.g. 10500, 10501). If there is any discrepancy, then payment types and payment amounts of both the payroll system and the financial accounting system can be shown separately.

FIG. 6 illustrates another exemplary reconciliation report 600 that is generated based on a user selection of reconciliation between a payroll system, a financial accounting system, and a travel management system. The reconciliation report 600 includes employee identification numbers (e.g. 10500), general ledger account number (e.g. 76025000), trip number (e.g. 245675), payment type (e.g. per diem), and payment amount associated with the payment type, and a pay period. The data displayed in the report 600 is collated from the data that is captured and stored as shown in FIG. 4. From this reconciliation report 600 it can be interpreted that debit to general ledger account number 76025510 is the settlement of per diem amount $3200 to the employee (10500) for the trip number 245675 and the amount $3200 is paid to the employee (10500) in pay period ‘2.’ No discrepancy exists between payment types and payment amounts. If there is any discrepancy, then payment types and payment amounts of the payroll system, the financial accounting system, and travel management system can be shown separately.

The data stored in the individual systems had been typically used to generate individual reports. Retrieving the data from the databases associated with these individual systems to generate any reports may not provide required flexibility and functionality. Moreover, data entering operations of various systems may not capture all the required information in associated databases. Capturing data of various systems and storing the data in a dedicated data warehouse provides more flexibility and increased functionality to perform several analytic operations such as generation of various types of reports. All the required data including any data that would generally be not entered or captured in the databases (such as time references) can be captured and stored in a data warehouse.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

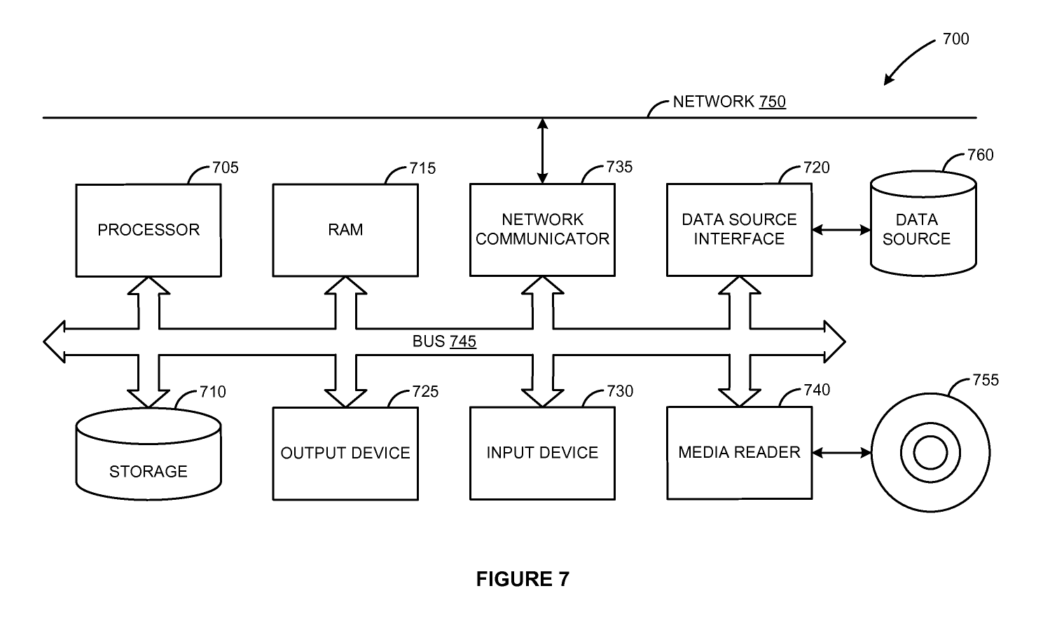

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
capture and store one or more identifiers, one or more payment parameters, and one or more time references for one or more data entering operations of a plurality of related systems;
initiate a query based on a user-selection for reconciliation of at least a first system and a second system of the plurality of systems; and
in response to the query, generate a reconciliation report comprising a collation of the identifiers, the payment parameters, and the time references of the first system and the second system.

2. The article of manufacture of claim 1, further comprising instructions which when executed by the computer further causes the computer to:
display the reconciliation report.

3. The article of manufacture of claim 1, wherein the instructions to capture the time reference, comprises instructions to:
capture a first time reference; and
determine a second time reference from the first time reference.

4. The article of manufacture of claim 3, wherein the first time reference is a posting date and the second time reference is a pay period.

5. The article of manufacture of claim 1, wherein the payment parameter comprises payment type, payment amount, payee, payer, or combinations thereof.

6. The article of manufacture of claim 5, wherein each of the one or more identifiers is associated with at least one of the payment parameter.

7. The article of manufacture of claim 1, wherein the first system is a human resource payroll system and the second system comprises at least one of a financial accounting system, a travel management system, and a fund management system.

8. A computerized method for payroll reconciliation, the method comprising:
capturing and storing one or more identifiers, one or more payment parameters, and one or more time references for one or more data entering operations of a plurality of related systems;
initiating a query based on a user-selection for reconciliation of at least a first system and a second system of the plurality of systems; and
in response to the query, generating a reconciliation report comprising a collation of the identifiers, the payment parameters, and the time references of the first system and the second system.

9. The method of claim 8, further comprising:
displaying the reconciliation report.

10. The method of claim 8, wherein capturing the time reference, comprises:
capturing a first time reference; and
determining a second time reference from the first time reference.

11. The method of claim 10, wherein the first time reference is a posting date and the second time reference is a pay period.

12. The method of claim 8, wherein the payment parameter comprises payment type, payment amount, payee, payer, or combinations thereof.

13. The method of claim 12, wherein each of the one or more identifiers is associated with at least one of the payment parameter of an application of the plurality of applications.

14. The method of claim 8, wherein the first system is a human resource payroll system and the second system comprises at least one of a financial accounting system, a travel management system, and a fund management system.

15. A computer system for payroll reconciliation, comprising:
a computer memory to store program code; and
a processor to execute the program code to:
capture and store one or more identifiers, one or more payment parameters, and one or more time references for one or more data entering operations of a plurality of related systems;
initiate a query based on a user-selection for reconciliation of at least a first system and a second system of the plurality of systems; and
in response to the query, generate a reconciliation report comprising a collation of the identifiers, the payment parameters, and the time references of the first system and the second system.

16. The system of claim 15, wherein the processor further executes the program code to:
display the reconciliation report.

17. The system of claim 15, wherein the program code to capture the time reference, comprises program code to:
capture a first time reference; and
determine a second time reference from the first time reference.

18. The system of claim 17, wherein the first time reference is a posting date and the second time reference is a pay period.

19. The system of claim 15, wherein the payment parameter comprises payment type, payment amount, payee, payer, or combinations thereof.

20. The system of claim 19, wherein each of the one or more identifiers is associated with at least one of the payment parameter of an application of the plurality of applications.

21. The system of claim 15, wherein the first system is a human resource payroll system and the second system comprises at least one of a financial accounting system, a travel management system, and a fund management system.
